(19) United States
(12) Patent Application Publication
(10) Pub. No.: US 2017/0346405 A1
(43) Pub. Date: Nov. 30, 2017

(54) DUAL-MODE OPERATION CONTROLLER FOR FLYBACK CONVERTER WITH PRIMARY-SIDE REGULATION

(71) Applicant: INNO-TECH CO., LTD., Taipei City (TW)

(72) Inventors: Ching-Yuan Lin, Taipei City (TW); Shu-Chia Lin, Taipei City (TW); Wen-Yueh Hsieh, Taipei City (TW); Chih Feng Lin, Taipei City (TW)

(21) Appl. No.: 15/164,939

(22) Filed: May 26, 2016

(51) Int. Cl. H02M 3/335; H02M 1/08; H02M 1/00

(52) U.S. Cl. CPC H02M 3/33515; H02M 1/08; H02M 2001/0009

(57) ABSTRACT

Disclosed is a dual-mode operation controller in collocation with an input capacitor, a flyback transformer, a first primary-side switch, a second primary-side switch, a current-sensing resistor, a primary-side voltage-sensing unit, a secondary-side rectifier, and an output capacitor as a Primary-Side Regulation (PSR) flyback converter, which is dynamically controlled to operate in two operating modes, including Quasi-Resonant-Discontinuous Conduction Mode (QR-DCM) and Continuous Conduction Mode (CCM), in accordance with a loading condition so as to convert a unregulated DC input voltage source into a regulated DC output voltage source. The dual-mode operation controller has at least 5 pins, and the flyback transformer includes a primary-side winding, a secondary-side winding, and an auxiliary winding. The first primary-side and second primary-side switches are connected in series with the current-sensing resistor and placed at the low side of the primary-side winding, and the second primary-side switch is driven by the dual-mode operation controller.

### BACKGROUND OF THE INVENTION

### 1. Field of the Invention

The present invention relates to an operation controller for flyback converter, and more specifically to a dual-mode operation controller for flyback converter with Primary-Side Regulation (PSR) to dynamically control a flyback converter to operate in Discontinuous Conduction Mode (DCM) within a relatively light load range for the purpose of optimizing the light-load conversion efficiencies by minimizing the dominant switching loss or in Continuous Conduction Mode (CCM) within a relatively heavy load range for the purpose of optimizing the heavy-load conversion efficiencies by minimizing the dominant conduction loss so that the average conversion efficiency can be optimized throughout the entire load range.

### 2. The Prior Arts

Various electric/electronic devices operate off of a specific operating voltage. For example, ICs (integrated circuits) are generally supplied with 5V, 3V, or 1.8V DC, some DC motors need 12V DC, and high-power devices require 110V or 220V AC from AC mains. In particular, the lamp of the LED display usually operates off of a much higher operating voltage. Thus, many kinds of power converters or inverters have been developed to meet those various demands.

Flyback converter, which has the advantage of simpler architecture and wider operating voltage range, is one of the most widely used switching power converters. As a result, flyback converter is almost omnipresent/ubiquitous in electronic devices consuming low to medium power. More specifically, flyback converter leverages switching components to manipulate the energy, stored to and released from a coupled inductor (also called a flyback transformer by the industry) based on the volt-second balance principle, so as to deliver the required output power. At the same time, passive Resistor-Capacitor-Diode (RCD) dampers and Resistor-Capacitor (RC) snubbers are used to suppress the voltage stress on the switching components by means of absorbing voltage spikes resulting from the leakage inductance of the flyback transformer.

In prior arts, Quasi-Resonant (QR) technology is broadly utilized to improve the conversion efficiency by reducing the switching loss of the primary-side switching component, switched on at a certain detected voltage valley during the Quasi-Resonant time after the flyback transformer gets completely demagnetized when the flyback converter operates in DCM. Leaving other operating modes aside, flyback converters generally have two operating modes: DCM and CCM. DCM and CCM each have advantages and disadvantages. In general, DCM provides better switching conditions for the rectifier diodes, since the diodes are operating at zero current just before becoming reverse biased and the reverse recovery loss is minimized. Also in DCM, the primary-side switching component has the chance of being switched on at a certain detected voltage valley with the benefit of reduction in the switching loss and alleviation of Electromagnetic Interference (EMI) in the course of Quasi-Resonance between the primary inductor and the drain-source capacitor, when the primary inductor is set free from the clamping voltage −nVₒ and throws itself into the Quasi-Resonance with the drain-source capacitor after the complete flyback transformer demagnetization. The flyback transformer can be downsized using DCM because the average energy storage is low compared to that in CCM. However, DCM causes high RMS current, which increases the conduction loss of the primary Metal-Oxide-Semiconductor Field Effect Transistor (MOSFET) severely for low-line condition. Thus, DCM, enabling valley switching and reducing switching loss within a relatively light load range, would get the short end of the stick within a relatively heavy load range, where CCM has the upper hand.

Flyback converters in prior arts can generally be classified into two categories in terms of valley switching: the first category goes without valley switching and the second category comes with valley switching. The problem with the first category is that the primary-side switching component is hard-switched at a higher switching loss. The problem with the second category is that the soft-switched flyback converter always operating in DCM to keep valley switching suffers a higher conduction loss. As such, neither the first category nor the second category can get the best of both worlds for reduced switching loss and reduced conduction loss.

In order to kill two birds with one stone, the present invention proposes a dual-mode operation controller, which can dynamically control a flyback converter to operate in QR-DCM within a relatively light load range to optimize the light-load conversion efficiencies by means of minimizing the dominant switching loss and in CCM within a relatively heavy load range to optimize the heavy-load conversion efficiencies by means of minimizing the dominant conduction loss, for the conversion efficiency to stay high throughout the entire load range, leading to significant improvement on the high/low-line average efficiencies, averaged over 25%, 50%, 75%, and 100% loadings at 115 Vac and 230 Vac.

### SUMMARY OF THE INVENTION

The primary objective of the present invention is to provide a dual-mode operation controller for flyback converter with PSR. The dual-mode operation controller, lying at the heart of a PSR flyback converter, can be used in collocation with an input capacitor, a flyback transformer, a first primary-side switch, a second primary-side switch, a current-sensing resistor, a primary-side voltage-sensing unit, a secondary-side rectifier, and an output capacitor for converting an unregulated DC input voltage source into a regulated DC output voltage source some DC-powered devices can operate off of The dual-mode operation controller dynamically controls a PSR flyback converter to operate in two operating modes, QR-DCM and CCM, in accordance with the loading condition. The first primary-side switch and the second primary-side switch, connected in series with a current-sensing resistor and placed at the low side of a primary-side winding, can be but will not be limited to a power MOSFET or a power Bipolar Junction Transistor (BJT). The secondary-side rectifier, which can be placed either at the secondary low side or at the secondary high side, can be but will not be limited to a diode rectifier or a synchronous rectifier.

For the sake of simplifying the description of the present invention, both the first primary-side switch and the second primary-side switch would be assumed hereafter to be a power MOSFET. The first primary-side switch is termed source-driven while the second primary-side switch is termed gate-driven because the former has its gate clamped at a nearly constant Zener breakdown voltage as a reference potential and its source driven by the drain of the second primary-side switch while the latter has its gate driven by the Gate pin of the dual-mode operation controller and its source clamped at a negligibly low current sense voltage as a reference potential. The first primary-side switch would get switched on if its source is connected to the primary-side ground when the second primary-side switch gets switched on. The first primary-side switch would get switched off if its source is disconnected from the primary-side ground when the second primary-side switch gets switched off. In other words, the switch-on/off of the first primary-side switch would be in sync with the switch-on/off of the second primary-side switch.

Specifically, the input capacitor supplies a unregulated DC input voltage, typically ranging from 127 to 373 Vdc as a result of peak-rectifying a universal AC input voltage of 90˜264 Vac. The flyback transformer comprises a primary-side winding, a secondary-side winding, and an auxiliary winding, which are typically wound in a sandwich winding structure and therefore well coupled to each other. The primary-side winding is connected in series with the input capacitor, the first primary-side switch, the second primary-side switch, and the current-sensing resistor to form an energy-storing power loop in the primary side. The secondary-side winding is connected in series with the secondary-side rectifier and the output capacitor to form an energy-releasing power loop in the secondary side. The auxiliary winding is connected to the Voltage Sense (VS) pin through a voltage divider and a voltage damper to form a voltage-sensing signal loop for PSR.

The VS pin would be clamped at a slightly negative/positive potential (−0.3V/0.15V typical) when both the first primary-side switch and the second primary-side switch switch on to store energy and the auxiliary winding induces a negative voltage

$$- \frac{{N}_{A}}{{N}_{P}} {V}_{IN} .$$

The VS pin would sense a scaled-down reflected output voltage

$$\frac{{N}_{A}}{{N}_{S}} {V}_{O} \times \frac{{R}_{B}}{{R}_{A} + {R}_{B}} ,$$

which is used for PSR, when both the first primary-side switch and the second primary-side switch switch off to release energy and the auxiliary winding induces a positive voltage

$$\frac{{N}_{A}}{{N}_{S}} {V}_{O} .$$

The auxiliary winding here, indispensable for the implementation/realization of PSR, has nothing to do with the continuous and steady working voltage supply to the dual-mode operation controller, whose VDD pin is powered with a regulated voltage derived from the unregulated DC input voltage source through the voltage regulator.

The dual-mode operation controller, which can have but will not be limited to having 5 exemplary pins: VDD pin (supply voltage input), GND pin (reference ground), Gate pin (gate driver output), CS pin (current sense input), and VS pin (voltage sense input), has its VDD pin connected to the input capacitor through a voltage regulator and the gate of the first primary-side switch; its GND pin connected to the low side of the input capacitor, the low side of the voltage divider, the low side of the voltage damper, the low side of the voltage regulator, and the low side of the current-sensing resistor; its Gate pin connected to the gate of the second primary-side switch; its CS pin connected to the source of the second primary-side switch and the high side of the current-sensing resistor; and its VS pin connected to the high side of the voltage damper and the midpoint of the voltage divider.

More specifically, the dual-mode operation controller would drive the second primary-side switch in response to the voltage sense signal from the voltage-sensing unit and the current sense signal from the current-sensing resistor. The combination of the voltage sense signal from the voltage-sensing unit and the current sense signal from the current-sensing resistor would clue the dual-mode operation controller in on what the loading status is.

The dual-mode operation controller would then direct/signal the flyback converter to operate in QR-DCM at light loads to optimize the light-load conversion efficiencies by means of reducing the dominant switching loss and in CCM at heavy loads to optimize the heavy-load conversion efficiencies by means of reducing the dominant conduction loss.

Therefore, the boundary between QR-DCM and CCM, also called BCM for easy reference, can be reasonably preset for a specific nominal output power to get the best out of the dual-mode operation control. For example, BCM can be preset at 75% of the nominal output power for a 115 Vac input and at 100% for a 230 Vac input if the nominal output power is 20 W and the switching loss prevails over the conduction loss; BCM can be preset at 50% of the nominal output power for a 115 Vac input and at 75% for a 230 Vac input if the nominal output power is 60 W and the conduction loss prevails over the switching loss.

In a nutshell, the disclosed dual-mode operation controller for PSR flyback converters brings forward an effective means for facilitating the efficient optimization of the 4-point average conversion efficiencies both at the 115 Vac low line and at the 230 Vac high line to meet or exceed the increasingly stringent DoE (Department of Energy) and CoC (Code of Conduct) efficiency requirements.

### BRIEF DESCRIPTION OF THE DRAWINGS

The present invention will be apparent to those skilled in the art by reading the following detailed description of a preferred embodiment thereof, with reference to the attached drawings, in which:

FIG. 1 shows a PSR flyback converter built around the dual-mode operation controller according to the first embodiment of the present invention;

FIG. 2 shows efficiency curves contrasting QR-DCM and CCM at the 115 Vac low line in the load range of 20 to 200 W;

FIG. 3 shows efficiency curves contrasting QR-DCM and CCM at the 230 Vac high line in the load range of 20 to 200 W; and

FIG. 4 shows a PSR flyback converter built around the dual-mode operation controller according to the second embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

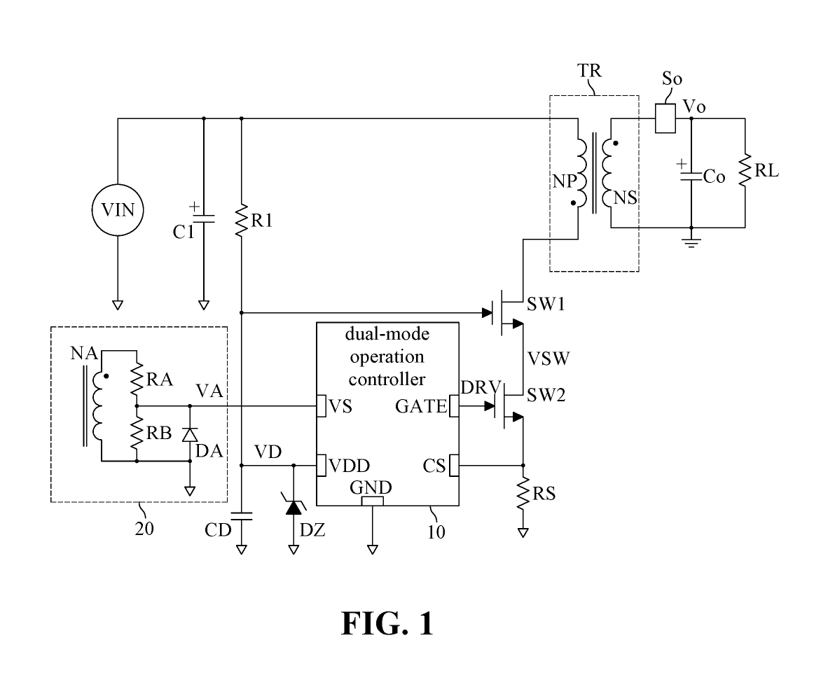

Please refer to FIG. 1 for a PSR flyback converter built around the dual-mode operation controller according to the first embodiment of the present invention. The dual-mode operation controller 10 in the first embodiment, lying at the heart of a PSR flyback converter, can be used in collocation with an input capacitor C1, a flyback transformer TR, a first primary-side switch SW1, a second primary-side switch SW2, a current-sensing resistor RS, a primary-side voltage-sensing unit 20, a secondary-side rectifier So, and an output capacitor Co for converting a unregulated DC input voltage source V_{IN} into a regulated DC output voltage source Vₒ some DC-powered devices can operate off of. The dual-mode operation controller 10 dynamically controls the PSR flyback converter to operate in two operating modes, QR-DCM and CCM, in accordance with the loading condition. The first primary-side switch SW1 and the second primary-side switch SW2, connected in series with the current-sensing resistor RS and placed at the low side of the primary-side winding N_{P}, can be but will not be limited to a power MOSFET or a power BJT. The secondary-side rectifier So, which can be placed either at the secondary low side or at the secondary high side, can be but will not be limited to a diode rectifier or a synchronous rectifier.

For the sake of simplifying the description of the present invention, both the first primary-side switch SW1 and the second primary-side switch SW2 would be assumed hereafter to be a power MOSFET. The first primary-side switch SW1 is termed source-driven while the second primary-side switch SW2 is termed gate-driven because the former has its gate clamped at a nearly constant Zener breakdown voltage as a reference potential and its source driven by the drain of the second primary-side switch SW2 while the latter has its gate driven by the Gate pin of the dual-mode operation controller 10 and its source clamped at a negligibly low current sense voltage as a reference potential. The first primary-side switch SW1 would get switched on if its source is connected to the primary-side ground when the second primary-side switch SW2 gets switched on. The first primary-side switch SW1 would get switched off if its source is disconnected from the primary-side ground when the second primary-side switch SW2 gets switched off. In other words, the switch-on/off of the first primary-side switch SW1 would be in sync with the switch-on/off of the second primary-side switch SW2.

Specifically, the input capacitor C1 supplies a unregulated DC input voltage, typically ranging from 127 to 373 Vdc as a result of peak-rectifying a universal AC input voltage of 90˜264 Vac, because the input capacitor C1 in collocation with a bridge rectifier (not shown in FIG. 1 for brevity) forms a peak rectifier for the AC mains. The flyback transformer TR comprises a primary-side winding N_{P}, a secondary-side winding N_{S}, and an auxiliary winding N_{A}, which are typically wound in a sandwich winding structure and therefore well coupled to each other. The primary-side winding N_{P} is connected in series with the input capacitor C1, the first primary-side switch SW1, the second primary-side switch SW2, and the current-sensing resistor RS to form an energy-storing power loop in the primary side. The secondary-side winding N_{S} is connected in series with the secondary-side rectifier So and the output capacitor Co to form an energy-releasing power loop in the secondary side. The auxiliary winding N_{A} is connected to the VS pin through a voltage divider (RA and RB) and a voltage damper (DA) to form a voltage-sensing signal loop for PSR.

The VS pin would be clamped at a slightly negative/positive potential (−0.3V/0.15V typical) when both the first primary-side switch SW1 and the second primary-side switch SW2 switch on to store energy and the auxiliary winding N_{A} induces a negative voltage

$$- \frac{{N}_{A}}{{N}_{P}} {V}_{IN} .$$

The VS pin would sense a scaled-down reflected output voltage

$$\frac{{N}_{A}}{{N}_{S}} {V}_{O} \times \frac{{R}_{B}}{{R}_{A} + {R}_{B}} ,$$

which is used for PSR, when both the first primary-side switch SW1 and the second primary-side switch SW2 switch off to release energy and the auxiliary winding N_{A} induces a positive voltage

$$\frac{{N}_{A}}{{N}_{S}} {V}_{O} .$$

The auxiliary winding N_{A} here, indispensable for the implementation/realization of PSR, has nothing to do with the continuous and steady working voltage supply to the dual-mode operation controller 10, whose VDD pin is powered with a regulated voltage derived from the unregulated DC input voltage source V_{IN} through the voltage regulator (R1, CD, and DZ).

The dual-mode operation controller 10, which can have but will not be limited to having 5 exemplary pins: VDD pin (supply voltage input), GND pin (reference ground), Gate pin (gate driver output), CS pin (current sense input), and VS pin (voltage sense input), has its VDD pin connected to the input capacitor C1 through a voltage regulator (R1, CD, and DZ) and the gate of the first primary-side switch SW1; its GND pin connected to the low side of the input capacitor C1, the low side of the voltage divider (RA and RB), the low side of the voltage damper DA, the low side of the voltage regulator (R1, CD, and DZ), and the low side of the current-sensing resistor RS; its Gate pin connected to the gate of the second primary-side switch SW2; its CS pin connected to the source of the second primary-side switch SW2 and the high side of the current-sensing resistor RS; and its VS pin connected to the high side of the voltage damper DA and the midpoint of the voltage divider (RA and RB).

When both the first primary-side switch SW1 and the second primary-side switch SW2 are switched on to store energy, the current sense signal, fetched from the high side of the current-sensing resistor RS, is fed to the CS pin. Meanwhile, the VS pin receives no voltage sense signal because of being clamped at a slightly negative/positive potential (−0.3V/0.15V typical) due to the functioning voltage damper DA, activated by the induced negative voltage

$$- \frac{{N}_{A}}{{N}_{P}} {V}_{IN} .$$

across the auxiliary winding N_{A} and protecting the VS pin against an excessively negative voltage.

When the secondary-side rectifier So is turned on to release energy, the voltage sense signal, fetched from the midpoint of the voltage divider RA and RB (the scaled-down reflected output voltage,

$$\frac{{N}_{A}}{{N}_{S}} {V}_{O} \times \frac{{R}_{B}}{{R}_{A} + {R}_{B}} ,$$

is used for PSR), is fed to the VS pin. Meanwhile, the CS pin receives no current sense signal because of being shorted to the primary-side ground due to the non-conducting first primary-side switch SW1 and second primary-side switch SW2, switched off by the GATE pin of the dual-mode operation controller 10 and resetting the ramp voltage across the current-sensing resistor RS.

More specifically, the dual-mode operation controller 10 would drive the second primary-side switch SW2 in response to the voltage sense signal from the voltage-sensing unit 20 and the current sense signal from the current-sensing resistor RS. The combination of the voltage sense signal from the voltage-sensing unit 20 and the current sense signal from the current-sensing resistor RS would clue the dual-mode operation controller 10 in on what the loading status is.

The dual-mode operation controller 10 would then direct/signal the flyback converter to operate in QR-DCM at light loads to optimize the light-load conversion efficiencies by means of reducing the dominant switching loss and in CCM at heavy loads to optimize the heavy-load conversion efficiencies by means of reducing the dominant conduction loss.

Therefore, the boundary between QR-DCM and CCM, also called BCM for easy reference, can be reasonably preset for a specific nominal output power to get the best out of the dual-mode operation control. For example, BCM can be preset at 75% of the nominal output power for a 115 Vac input and at 100% for a 230 Vac input if the nominal output power is 20 W and the switching loss prevails over the conduction loss; BCM can be preset at 50% of the nominal output power for a 115 Vac input and at 75% for a 230 Vac input if the nominal output power is 60 W and the conduction loss prevails over the switching loss.

In a nutshell, the disclosed dual-mode operation controller 10 for PSR flyback converters brings forward an effective means for facilitating the efficient optimization of the 4-point average conversion efficiencies both at the 115 Vac low line and at the 230 Vac high line to meet or exceed the increasingly stringent DoE (Department of Energy) and CoC (Code of Conduct) efficiency requirements.

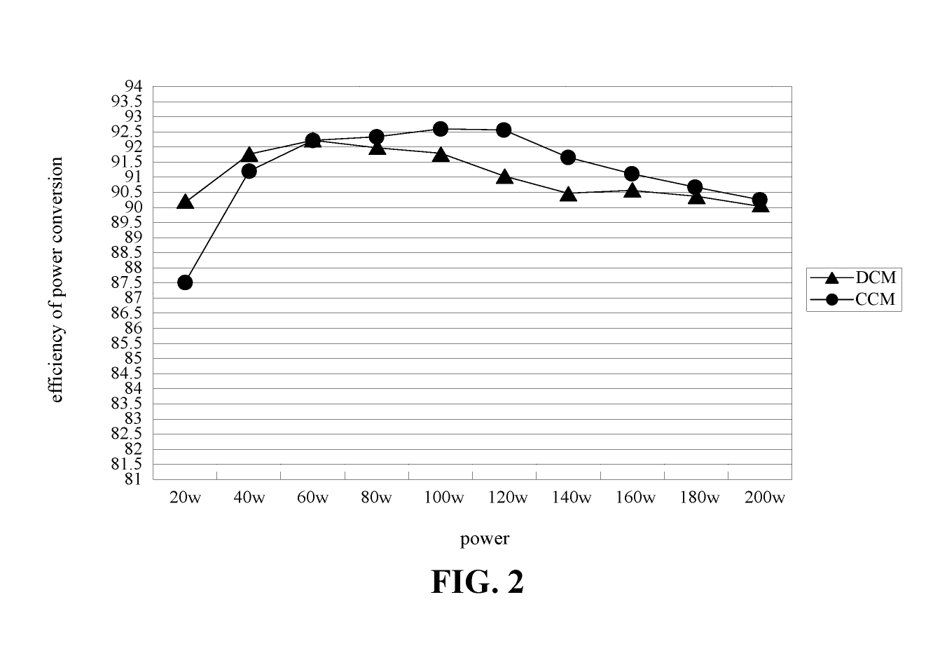

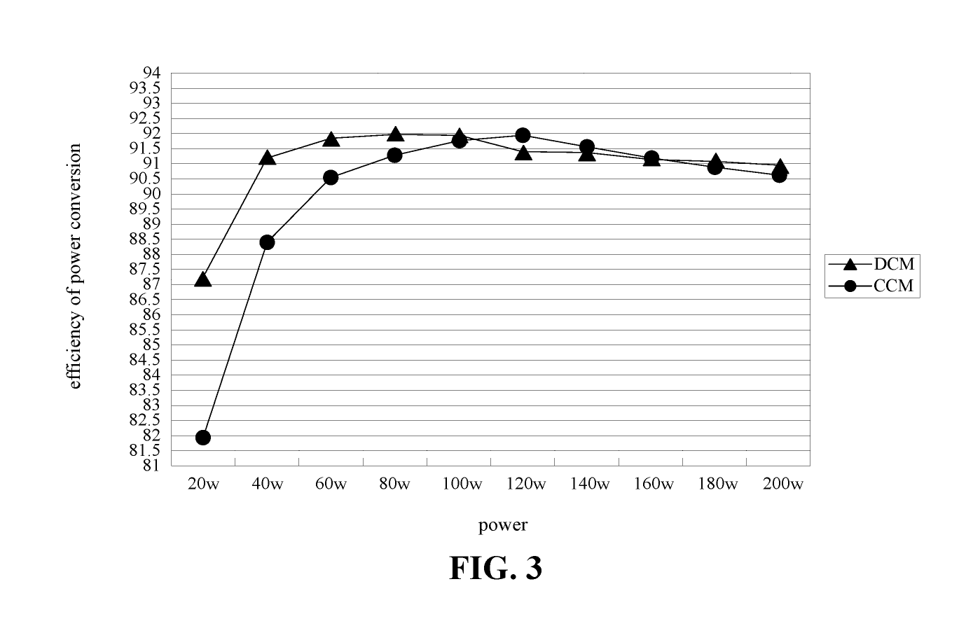

Now, please refer to FIGS. 2 and 3 for efficiency curves contrasting QR-DCM and CCM at the 115 Vac low line and at the 230 Vac high line in the load range of 20 to 200 W. It is crystal clear that QR-DCM optimizes light-load conversion efficiencies while CCM optimizes heavy-load conversion efficiencies. To get the best of both worlds out of the dual-mode operation control, the optimal BCM between QR-DCM and CCM to optimize 4-point average efficiencies can be cherry-picked as the golden cross of the QR-DCM efficiency curve (plotted as a function of the output load when the flyback converter operates all in QR-DCM) and the CCM efficiency curve (plotted as a function of the output load when the flyback converter operates all in CCM). From FIGS. 2 and 3 one can clearly see that the optimal BCM, highly depending on the power level, the circuit components, and other factors of the given flyback converter, would be 50˜70 W, translating to 25˜35% of the 200W nominal load, when it comes to the 115 Vac low line and 90˜110 W, translating to 45˜55% of the 200 W nominal load, when it comes to the 230 Vac high line.

This way, the flyback converter would be ushered into QR-DCM to optimize light-load conversion efficiencies by means of reducing dominant switching loss when the output load goes below the preset BCM level and into CCM to optimize heavy-load conversion efficiencies by means of reducing dominant conduction loss when the output load goes above the preset BCM level. Alternatively, another possible way for stably switching between QR-DCM and CCM with strengthened interference/noise immunity is to preset a hysteresis window with a lower threshold level and a higher threshold level instead of a single threshold level.

Some loose ends need to be tied up here. The first primary-side switch SW1 and the second primary-side switch SW2, exemplarily shown as two external switches in FIG. 1, can also be integrated into the dual-mode operation controller 10. The voltage damper DA can be but will not be limited to a diode. The voltage regulator R1, CD, and DZ can be but will not be limited to a Resistor-Capacitor-Zener (RCZ) regulator. It goes without saying that all the typical values above are given for concretization of the inventive concept instead of limitation on the present invention.

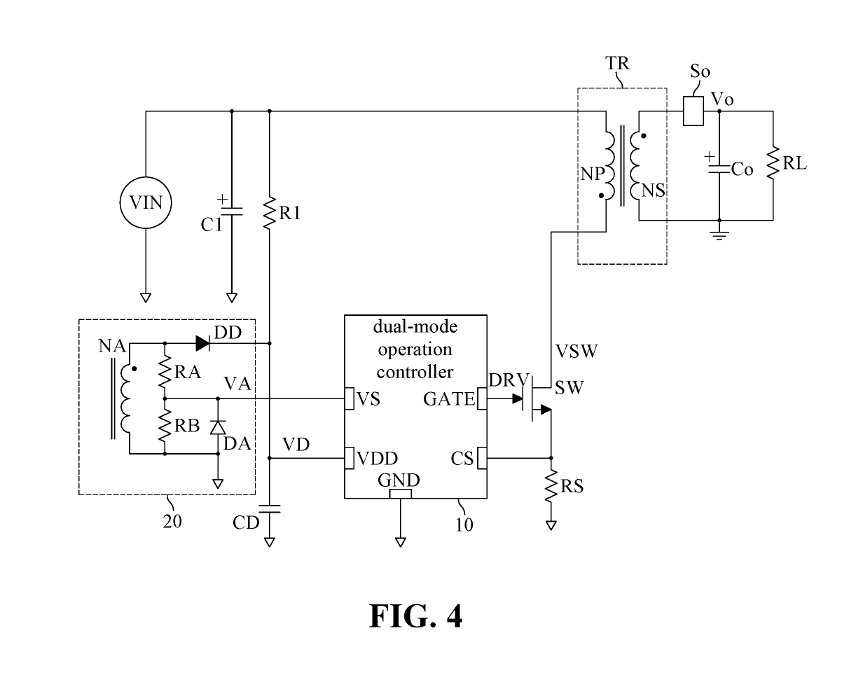

As an alternative to the first embodiment, featuring two cascaded and synchronized primary-side switches as a switching unit, please refer to FIG. 4 for a PSR flyback converter built around the dual-mode operation controller according to the second embodiment, featuring only one primary-side switch as a switching unit, of the present invention. The second embodiment has a lot in common with the first embodiment except the following differences:
A VDD diode rectifier DD is added in for the purpose of supplying the dual-mode operation controller 10 with a continuous and steady working voltage after startup, calling on the auxiliary winding N_{A} to wear two hats: PSR as well as continuous and steady working voltage supply.
The Zener diode DZ and the first primary-side switch SW1 are eliminated from the primary-side circuit as well as the second primary-side switch SW2 is renamed as a primary-side switch SW.

The primary-side winding N_{P} is connected in series with the input capacitor C1, the primary-side switch SW, and the current-sensing resistor RS to form an energy-storing power loop in the primary side. The dual-mode operation controller 10 starts switching the primary-side switch SW on and off when the unregulated DC input voltage source V_{IN} charges the VDD capacitor CD up to the startup level through the startup resistor R1 after power-on. The PSR flyback converter gets into its steady-state operation after the auxiliary winding N_{A} takes over the continuous and steady working voltage supply by replenishing the VDD capacitor VD with an induced voltage

$$\frac{{N}_{A}}{{N}_{S}} {V}_{O}$$

through the VDD diode rectifier DD, as long as the working voltage stays above the Undervoltage Lockout (UVLO) level. Identical/similar to that of the first embodiment, the operation principle of the second embodiment could be easily understood by analogy with no need to be restated herein.

Although the present invention has been described with reference to the preferred embodiments thereof, it is apparent to those skilled in the art that a variety of modifications and changes may be made without departing from the scope of the present invention which is intended to be defined by the appended claims.

1. A dual-mode operation controller in collocation with an input capacitor, a flyback transformer, a first primary-side switch, a second primary-side switch, a current-sensing resistor, a primary-side voltage-sensing unit, a secondary-side rectifier, and an output capacitor as a Primary-Side Regulation (PSR) flyback converter dynamically controlled to operate in two operating modes, Quasi-Resonant-Discontinuous Conduction Mode (QR-DCM) and Continuous Conduction Mode (CCM), in accordance with a loading condition so as to convert an unregulated DC input voltage source into a regulated DC output voltage source based on a preset ratio of nominal output power of the regulated DC output voltage source,
wherein the dual-mode operation controller has at least 5 pins including a VDD pin (supply voltage input), a GND pin (reference ground), a Gate pin (gate driver output), a CS pin (current sense input), and a VS pin (voltage sense input), the flyback transformer comprises a primary-side winding, a secondary-side winding, and an auxiliary winding, which are wound in a sandwich winding structure and coupled to each other, the first primary-side switch and the second primary-side switch are connected in series with the current-sensing resistor and placed at the low a first side of the primary-side winding, the secondary-side rectifier is placed either at a secondary low side or at a the secondary high side of the secondary-side winding, the first primary-side switch gets switched on if a source of the first primary-side switch is connected to the primary-side ground when the second primary-side switch gets switched on, the first primary-side switch gets switched off if the source of the first primary-side switch is disconnected from the primary-side ground when the second primary-side switch gets switched off, the second primary-side switch has a its gate driven by the Gate pin of the dual-mode operation controller, the input capacitor supplies an unregulated DC input voltage, the primary-side winding is connected in series with the input capacitor, the first primary-side switch, the second primary-side switch and the current-sensing resistor to form an energy-storing power loop in a primary side of the PSR flyback converter, the secondary-side winding is connected in series with the secondary-side rectifier and the output capacitor to form an energy-releasing power loop in a secondary side of the PSR flyback converter, the auxiliary winding is connected to the VS pin of the dual-mode operation controller through a voltage divider and a voltage damper to form a voltage-sensing signal loop for PSR, the VDD pin of the dual-mode operation controller is powered with a regulated voltage derived from the unregulated DC input voltage source through a voltage regulator and a gate of the first primary-side switch, the GND pin is connected to a first side of the input capacitor, a first side of the voltage divider, a first side of the voltage damper, a first side of the voltage regulator, and a first side of the current-sensing resistor, the CS pin is connected to a source of the second primary-side switch and a second side of the current-sensing resistor, the VS pin is connected to a second side of the voltage damper and a the midpoint of voltage divider, the dual-mode operation controller drives the second primary-side switch in response to a voltage sense signal from the voltage-sensing unit and a current sense signal from the current-sensing resistor, the combination of the voltage sense signal from the voltage-sensing unit and the current sense signal from the current-sensing resistor clues the dual-mode operation controller in on what the loading condition is, and the dual-mode operation controller directs/signals the flyback converter to operate in QR-DCM if the loading condition is less than the preset ratio to optimize light-load conversion efficiencies by means of reducing a dominant switching loss and in CCM if the loading condition is greater than the preset ratio to optimize heavy-load conversion efficiencies by means of reducing a dominant conduction loss.

2. The dual-mode operation controller as claimed in claim 1, wherein each of the first primary-side switch and the second primary-side switch is a power Metal-Oxide-Semiconductor Field Effect Transistor (MOSFET) or a power Bipolar Junction Transistor (BJT).

3. The dual-mode operation controller as claimed in claim 1, wherein the secondary-side rectifier is a diode rectifier or a synchronous rectifier.

4. The dual-mode operation controller as claimed in claim 1, wherein the unregulated DC input voltage ranges from 127 to 373 Vdc.

5. The dual-mode operation controller as claimed in claim 1, wherein a boundary between QR-DCM and CCM, also called BCM, is preset for a specific nominal output power of the regulated DC output voltage source.

6. The dual-mode operation controller as claimed in claim 5, wherein the BCM is preset at 75% of the specific nominal output power for a 115 Vac input and at 100% for a 230 Vac input if the specific nominal output power is 20 W, and the BCM is further preset at 50% of the specific nominal output power for a 115 Vac input and at 75% for a 230 Vac input if the specific nominal output power is 60 W.

7. (canceled)

8. The dual-mode operation controller as claimed in claim 1, wherein the first primary-side switch and the second primary-side switch are integrated into the dual-mode operation controller.

9. The dual-mode operation controller as claimed in claim 1, wherein the voltage clamper is a diode, and the voltage regulator is a Resistor-Capacitor-Zener (RCZ) regulator.

10. A dual-mode operation controller in collocation with an input capacitor, a flyback transformer, a primary-side switch, a current-sensing resistor, a primary-side voltage-sensing unit, a secondary-side rectifier, and an output capacitor as a Primary-Side Regulation (PSR) flyback converter dynamically controlled to operate in two operating modes, Quasi-Resonant-Discontinuous Conduction Mode (QR-DCM) and Continuous Conduction Mode (CCM) in accordance with a loading condition so as to convert an unregulated DC input voltage source into a regulated DC output voltage source based on a preset ratio of nominal output power of the regulated DC output voltage source,
wherein the dual-mode operation controller has at least 5 pins including a VDD pin (supply voltage input), a GND pin (reference ground), a Gate pin (gate driver output), a CS pin (current sense input), and a VS pin (voltage sense input), the flyback transformer comprises a primary-side winding, a secondary-side winding, and an auxiliary winding, which are wound in a sandwich winding structure and coupled to each other, the primary-side switch is connected in series with the current-sensing resistor and placed at a first side of the primary-side winding, the secondary-side rectifier is placed either at a secondary low side or at a secondary high side of the secondary-side winding, the primary-side switch has a gate driven by the Gate pin of the dual-mode operation controller, the input capacitor supplies an unregulated DC input voltage, the primary-side winding is connected in series with the input capacitor, the primary-side switch, and the current-sensing resistor to form an energy-storing power loop in a primary side of the PSR flyback converter, the secondary-side winding is connected in series with the secondary-side rectifier and the output capacitor to form an energy-releasing power loop in a secondary side of the PSR flyback converter, the auxiliary winding is connected to the VS pin of the dual-mode operation controller through a voltage divider and a voltage clamper to form a voltage-sensing signal loop for PSR, the VDD pin of the dual-mode operation controller is supplied with a continuous and steady working voltage by the auxiliary winding after startup, the GND pin is connected to a first side of the input capacitor, a first side of the voltage divider, a first side of the voltage damper, and a first side of the current-sensing resistor, the CS pin is connected to a source of the primary-side switch and a second side of the current-sensing resistor, the VS pin is connected to a second side of the voltage clamper and a midpoint of the voltage divider, the dual-mode operation controller drives the primary-side switch in response to a voltage sense signal from the voltage-sensing unit and a current sense signal from the current-sensing resistor, the combination of the voltage sense signal from the voltage-sensing unit and the current sense signal from the current-sensing resistor clues the dual-mode operation controller in on what the loading condition is, and the dual-mode operation controller directs/signals the flyback converter to operate in QR-DCM if the loading condition is less than the preset ratio to optimize light-load conversion efficiencies by means of reducing a dominant switching loss and in CCM if the loading condition is greater than the preset ratio to optimize heavy-load conversion efficiencies by means of reducing a dominant conduction loss.

11. The dual-mode operation controller as claimed in claim 10, wherein the primary-side switch is a power Metal-Oxide-Semiconductor Field Effect Transistor or a power Bipolar Junction Transistor.

12. The dual-mode operation controller as claimed in claim 10, wherein the secondary-side rectifier is a diode rectifier or a synchronous rectifier.

13. The dual-mode operation controller as claimed in claim 10, wherein the unregulated DC input voltage ranges from 127 to 373 Vdc.

14. The dual-mode operation controller as claimed in claim 10, wherein a boundary between QR-DCM and CCM, also called BCM, is preset for a specific nominal output power of the regulated DC output voltage source.

15. The dual-mode operation controller as claimed in claim 14, wherein the BCM is preset at 75% of the specific nominal output power for a 115 Vac input and at 100% for a 230 Vac input if the specific nominal output power is 20 W, and the BCM is further preset at 50% of the specific nominal output power for a 115 Vac input and at 75% for a 230 Vac input if the specific nominal output power is 60 W.

16. (canceled)

17. The dual-mode operation controller as claimed in claim 10, wherein the primary-side switch is integrated into the dual-mode operation controller.

18. The dual-mode operation controller as claimed in claim 10, wherein the voltage damper is a diode.
